(19) United States
(12) Patent Application Publication
(10) Pub. No.: US 2008/0279992 A1
(43) Pub. Date: Nov. 13, 2008

(54) Holder for objects which melt, drip or leaves finger imprints

(75) Inventor: Michael Kahn, Livingston, NJ (US)

Correspondence Address: WEISS & WEISS;Suite 251, 300 Old Country Road, Mineola, NY, 11501, US

(73) Assignee: GZB CORPORATION

(21) Appl. No.: 11/800,674

(22) Filed: May 7, 2007

(51) Int. Cl. A47J 43/00; A23G 9/26

(52) U.S. Cl. 426/134; 248/694

(57) ABSTRACT

A holder for holding an object which melts or drips or leaves imprints on one's fingers comprising a handle and a protrusion section. The device can further comprise a slip prevention disk with is located between said handle and said protrusion section.

### FIELD OF THE INVENTION

The present invention relates to a holder for holding an object which melts or drips or leaves imprints on one's fingers comprising a handle and a protrusion section.

### BACKGROUND OF THE INVENTION

U.S. Pat. No. 6,182,854 relates to an ice cream cone and popsicle holder. The device catches dripping ice cream or popsicles. The holder has a container with a closed bottom and side walls. The side walls support a shelf which extends outwardly from the container and has an outer peripheral wall. The shelf also has an inner cone holding wall with drain holes located either in the shelf or cone holding wall. The popsicle holder preferably has a pair of aligned slots for popsicles with two sticks.

U.S. Pat. No. 4,992,283 relates to a frozen confection holder for toddlers. The invention is a combination of a mouth and lip conforming confection that is mounted on a drip catching, stylistically shaped biodegradable handle that can be grasped by a toddler. The drip catch device may either be of a consumable composition and secured to the handle by a musilage or formed integrally with the handle.

U.S. Design Pats. D382,085 and D442,764 relate to designs for ice cream holders.

U.S. Design Pat. D286,700 relates to the ornamental design for an ice-cream sandwich.

U.S. Pat. No. 6,941,982 relates to a food holder attachable to the outside of the food such as an ice cream cone for capturing liquid, the liquid to be captured by an absorbent material and in a plurality of channels and interconnections, for maximizing the surface of the absorbent material. The channels have openings to allow the liquid to enter via gravity.

U.S. Pat. No. 6,571,979 relates to a holder for an ice cream having a stick which includes a handle having a drip receiving cavity. A drip catchment member is attached to or formed integrally with the handle and includes a catchment surface for receiving drips from the ice cream. A stick receiving aperture receives the stick to support the ice cream above the catchment surface. A drain enables any drips caught by the catchment surface to migrate into the cavity.

U.S. Patent Publ. No. 2003/0129280 relates to a supported comestible comprising a frozen comestible or a non-frozen comestible that is supported by an edible support. The edible support has sufficient surface area inside the comestible to support the comestible. Protective, edible mess guards for the hands and fingers, protective, edible drip guards, free standing edible supports, and moisture proof barriers/coatings and sealants are included.

There are plenty of foods that when eaten stick to the fingers and hands of the person holding the food. Such food includes ice cream products, cakes, or any other finger foods. In the prior art there has been no way to make these foods pleasant to eat without creating a mess to the person trying to eat such foods.

### SUMMARY OF THE INVENTION

The present invention comprises a device which has a handle that can be held by a user, a protrusion section which is placed inside an object to hold the object on the device.

It is an object of the present invention for the device to further comprise a platform or opening for catching drippings.

It is an object of the present invention for the device to be made of biodegradable material.

It is an object of the present invention for the device to be made out of plastic.

It is an object of the present invention for the device to be made out of wood.

It is an object of the present invention for the device to be made out of metal.

It is an object of the present invention for the device to be approximately 2-10 inches tall.

It is an object of the present invention for the device to comprise a slip prevention disk.

It is an object of the present invention for the protrusion to be separated from the rest of the device by a round disk.

It is an object of the present invention for the round disk to be approximately ¼ inch to 2 inches from the rest of the device.

It is an object of the present invention for the protrusion about the disk to be flat.

It is an object of the present invention for the protrusion to measure approximately 1/16 inch to approximately ½ inches in thickness.

It is an object of the present invention for the device to be placed into the center of the object for which it will be holding.

It is an object of the present invention for the handle to be approximately ¼ to 3 inches in thickness.

It is an object of the present invention for the handle to have a logo printed on it.

It is an object of the present invention for the handle to be round or flat.

It is an object of the present invention for the protrusion to be ¼ inch or longer.

It is an object of the present invention for the handle to be hollow.

It is an object of the present invention for the handle to contain an object inside.

It is an object of the present invention for the hollow handle to have a prize or toy inside of it.

It is an object of the present invention to have the prize or toy inside covered by a wrapping around the handle, so that the user cannot see what is inside.

It is an object of the present invention for the handles to have holes in it to allow ones hand to breathe and not conduct heat.

It is an object of the present invention for the disk to be in the form of a rectangle or circle.

It is an object of the present invention for the disk to have on it protrusions to assist in holding the object.

It is an object of the present invention for the item to be held to be an ice cream sandwich, chipwich, flying saucer or other type of ice cream which is normally held in a person's hands.

It is an object of the present invention for the item to be held to be a cake, sandwich, pizza or any other type of finger food.

It is an object of the present invention for the device to be inserted into the ice cream or other food item prior to the item being frozen.

It is an object of the present invention for the device to be made of a single piece.

It is an object of the present invention for the device to be made of multiple pieces.

It is an object of the present invention for the protrusion to have a single point or screw at the end of it for being inserted into the object to be held.

It is an object of the present invention for the device to have multiple protrusions to be inserted into the object.

It is an object of the present invention for the protrusion to be able to pass through the center of the object to the outside.

It is an object of the present invention for a separate novelty to be added on to the end of the protrusion once it has passed through the object.

It is an object of the present invention for the device to be used multiple times.

It is an object of the present invention for the device to be thrown away after a single use.

It is an object of the present invention for multiple types of handles to be used with multiple types of protrusions so that the tops and bottoms can be used interchangeably.

### BRIEF DESCRIPTION OF THE DRAWINGS

FIG. 1 illustrates a view of the device being attached to an object held by a user.

FIG. 2 shows how the device is inserted into an object having two separate halves.

FIG. 3 shows a cross section of the device in FIG. 1 inserted into an object.

FIG. 4 shows the device prior to being assembled.

FIG. 5 shows the device prior to being assembled.

FIG. 6 shows the device and how it can be inserted into an object having a pre-cut center area.

FIG. 7 shows an embodiment of the present invention.

FIG. 8 shows a cross section of the embodiment shown in FIG. 7.

FIG. 9 shows an embodiment of the present invention.

FIG. 10 shows a cross section of the embodiment of FIG. 9.

FIG. 11 shows an unassembled embodiment of the present invention.

FIG. 12 illustrates how the device is inserted into the object.

FIG. 13 illustrates how the device is inserted into the object.

FIG. 14 shows an embodiment of the present invention.

FIG. 15 shows an embodiment of the present invention.

FIG. 16 shows an unassembled view of the device of the present invention.

FIG. 17 shows a cross section of the device shown in FIG. 16.

FIG. 18 shows an unassembled view of the device of the present invention.

FIG. 19 shows the device including an embodiment of a handle.

FIG. 20 shows the device including an embodiment of a handle.

FIG. 21 shows the device including an embodiment of a handle.

### DETAILED DESCRIPTION

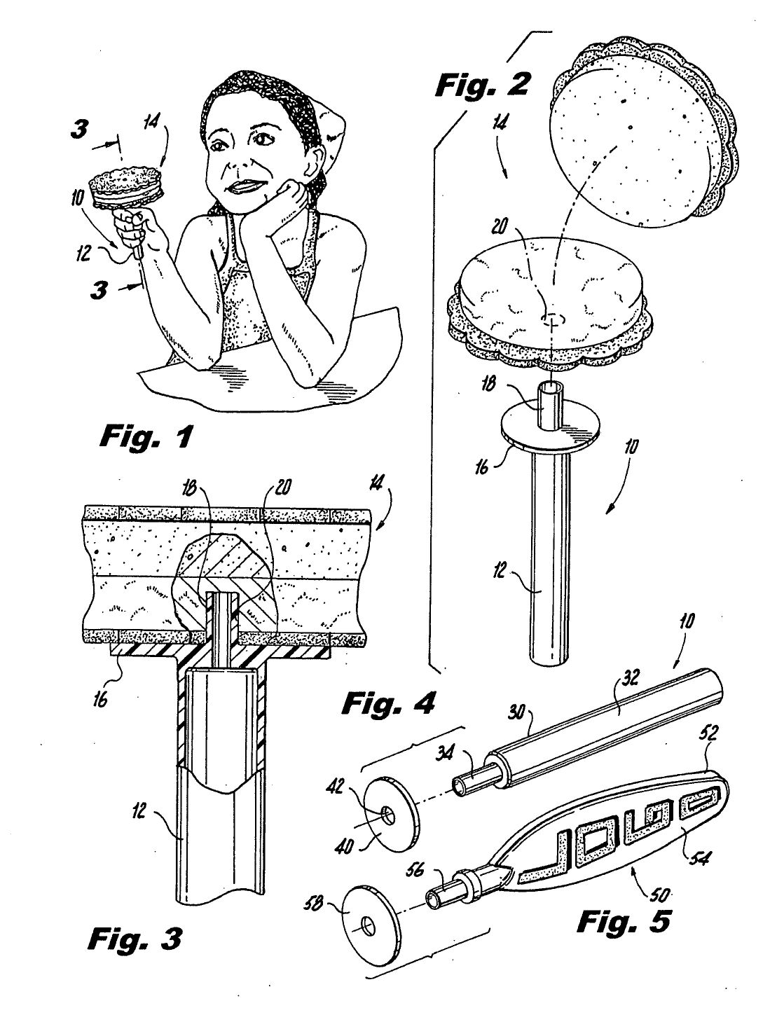

FIG. 1 shows a person holding the device 10 by the handle 12 holding an object 14. As shown in FIG. 1, the object is a flying saucer or chipwich.

FIG. 2 shows the device 10 having a handle 12. Above the handle 12 is a slip prevention disk 16 which allows the object 14 to rest on it so the object does not fall off or slide off the device 10. Above the slip preventive disk 16 is a protrusion 18 which goes through the center 20 of the object 14. As shown in FIG. 2, the object 14 is broken up into two halves.

FIG. 3 is a cross section of the device 10 shown in FIG. 1. FIG. 3 shows the handle 12, the slip prevention disk 16, and the protrusion 18 placed in the center 20 of object 14.

FIG. 4 shows the device 10 broken up into a piece 30 and a piece 40. Piece 30 comprises the handle 32 and the protrusion 34, the piece 40 comprises the slip prevention disk 40. As shown in FIG. 4, the slip disk prevention 40 has a hole 42 which is placed over the protrusion 34 and it sits on top of the handle 32.

FIG. 5 shows an alternative embodiment of the device 50. The device 50 has a handle 52 which has a larger surface area for putting on a logo 54. The device 50 further has the protrusion 56 and the slip prevention disk 58.

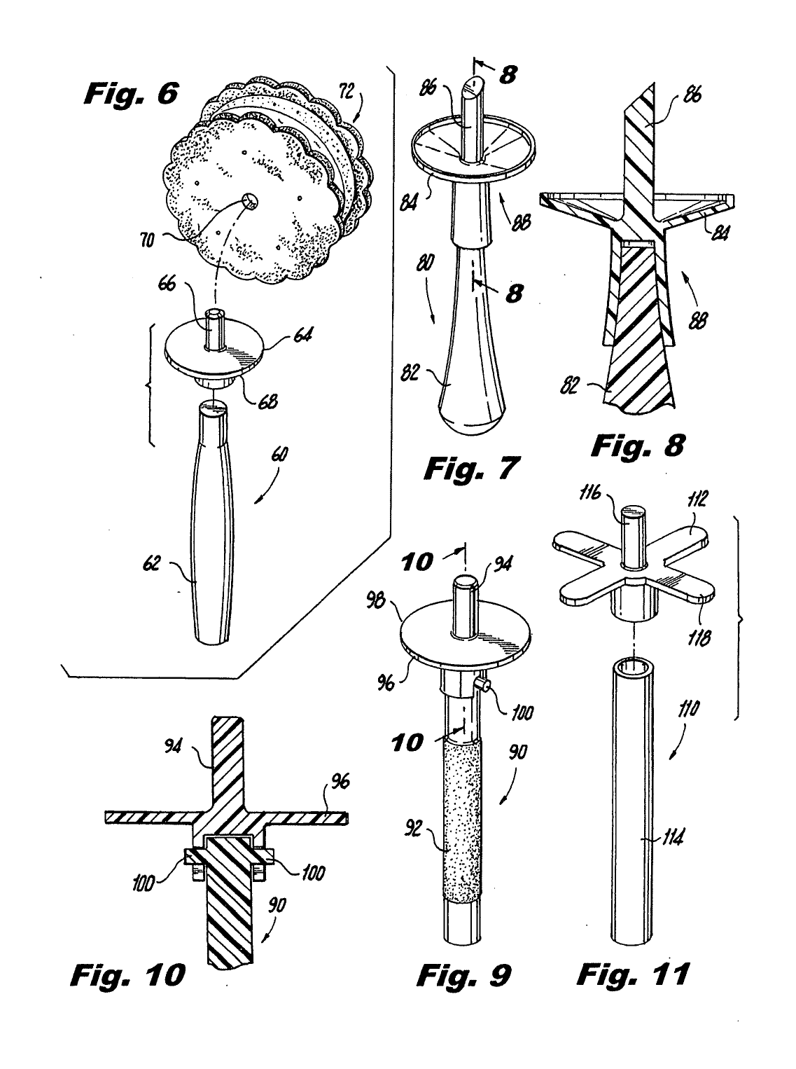

FIG. 6 shows an embodiment of the device 60 having the handle 62, a top portion 64 is made up of the protrusion 66 and the slip prevention disk 68. The top portion 64 is then attached to the handle 62. The protrusion 66 fits inside the center 70 of object 72.

FIG. 7 shows an embodiment of the device 80 having a handle portion 82 a slip prevention disk 84 and a protrusion 86. The slip prevention disk 84 can also be used to catch drippings. FIG. 8 shows a cross section of FIG. 7. FIG. 8 shows how the top piece 88 made up of the protrusion 86 and the slip prevention disk 84 is attached to the handle 82.

FIG. 9 shows an alternative embodiment 90 having a handle 92, the top portion 98 comprises the protrusion 94 and the slip prevention disk 96. The top portion 98 is placed onto the handle section 92 where it attaches to section 100.

FIG. 10 shows a cross section of FIG. 9.

FIG. 11 shows an embodiment of device 110 having a top portion 112, and a handle portion 114. The top portion 112 comprises protrusion 116 and slip prevention disk 118. The top portion 112 is slipped onto the handle 114.

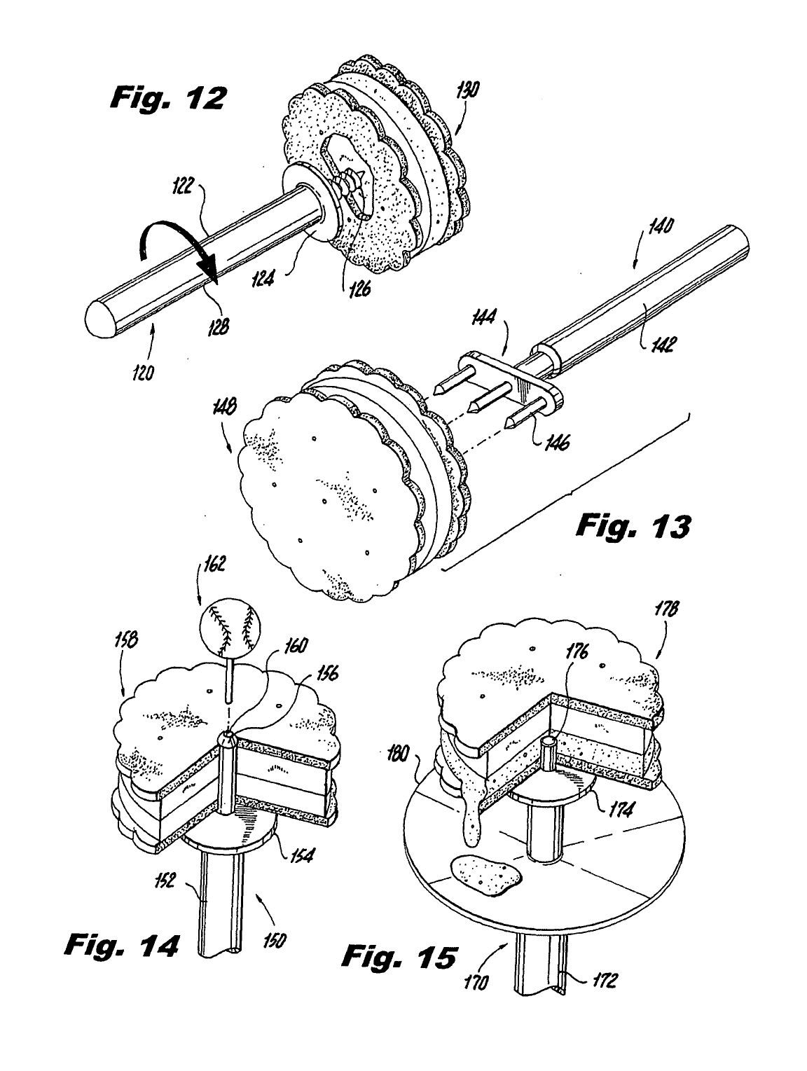

FIG. 12 shows the device 120 having handle section 122, a slip prevention disk 124 and a protrusion 126. In this embodiment, the protrusion 126 is formed like a screw and is turned such as shown by arrow 128 to screw into the center of object 130.

FIG. 13 shows an embodiment of the device 140 having a handle section 142 and a protrusion 144. In the device 140 the protrusion 144 is made up of three prongs 146 which are placed into the object 148.

FIG. 14 shows an embodiment of the device 150 having a handle section 152, a slip prevention disk 154 and a protrusion 156. The protrusion 156 is long enough to go through the entire center of the object 158. The protrusion 156 has a hole 160 in it for receiving a further novelty item 162.

FIG. 15 shows an embodiment of the device 170 having a handle 172, a slip prevention disk 174, a protrusion 176 which goes into the object 178. The device 170 further has a drip catching disk 180 which catches drippings from the object 178.

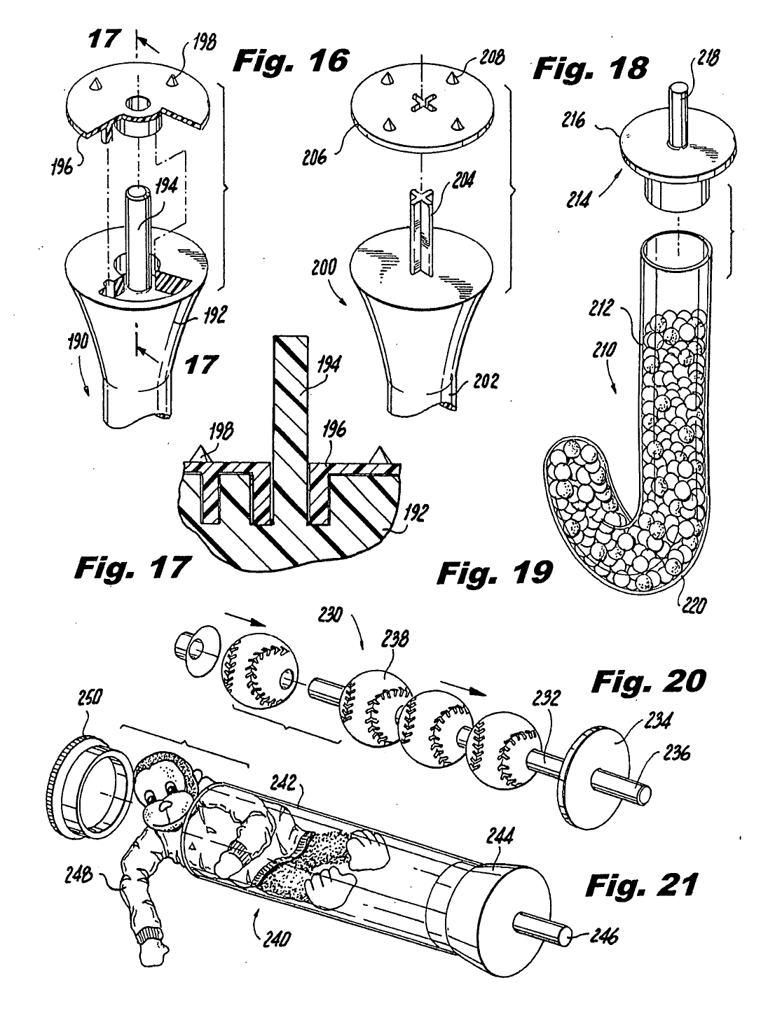

FIG. 16 shows an embodiment of the device 190 having a handle portion 192 and a protrusion 194. Attached to the handle portion is a disk 196 having further protrusions 198 for securing an object to it.

FIG. 17 is a cross section of the device 190 shown in FIG. 16.

FIG. 18 shows an embodiment of the device 200 having a handle section 202 and a protrusion 204. A disk 206 having further protrusions 208 is attached to the handle 202 allowing the protrusion 204 to go through the center of the disk 206.

FIG. 19 shows a further embodiment of the device 210 having a handle 212 and a top portion 214 comprising a slip prevention disk 216 and a protrusion portion 218. In this embodiment, the handle 212 is hollow so that objects 220 such as candy or other objects can be placed within the hollow handle 212.

FIG. 20 shows an embodiment of the device 230 having a handle section 232, a slip prevention disk 234 and a protrusion 236. The handle 232 can have objects such as balls 238 placed on it.

FIG. 21 shows an embodiment 240 having a handle section 242, a slip prevention disk 244 and a protrusion 246. The handle 242 is hollow and can receive a prize or novelty item 248. The novelty item 248 can be placed in the handle and the handle sealed with cap 250.

What is claimed is:

1. A device for holding an object which melts or drips or leaves imprints on one's fingers comprising;
a handle; and
a protrusion section.

2. The device of claim 1 further comprising a slip prevention disk which is located between said handle and said protrusion section.

3. The device of claim 1 further comprising a platform or opening for catching drippings.

4. The device of claim 1 wherein said device is made out of plastic, wood or metal.

5. The device of claim 1 wherein said device is approximately 2-10 inches tall.

6. The device of claim 2 wherein said slip prevention disk is approximately ½ inches to 2 inches in diameter.

7. The device of claim 2 wherein said disk is flat.

8. The device of claim 1 wherein said protrusion is approximately 1/16 inch to ½ inch in thickness.

9. The device of claim 1 wherein said device is placed into a center of said object.

10. The device of claim 1 wherein said handle is approximately ¼ inch to 3 inches in thickness.

11. The device of claim 1 wherein said handle has a logo printed on it.

12. The device of claim 1 wherein said protrusion is ¼ inch or longer.

13. The device of claim 1 wherein said handle is hollow.

14. The device of claim 13 wherein said handle contains an object inside.

15. The device of claim 14 wherein said object is a prize or toy.

16. The device of claim 14 wherein said handle has a wrapping to cover said object inside.

17. The device of claim 1 wherein said handle has holes in it.

18. The device of claim 2 wherein in said slip prevention disk has protrusions on it.

19. The device of claim 1 wherein said object comprises ice cream.

20. The device of claim 1 wherein said object is a cake, sandwich, pizza or other type of finger food.

21. The device of claim 1 wherein said device is inserted into said object prior to said object being frozen.

22. The device of claim 1 wherein said device is made up of a single piece.

23. The device of claim 1 wherein said device is made up of multiple pieces.

24. The device of claim 1 wherein said device comprises multiple protrusions.

25. The device of claim 1 wherein said protrusion section passes from one side of the object to the other side of the object.

26. The device of claim 25 wherein said protrusion section has an object placed on its end once said protrusion passes through said object.

27. The device of claim 1 wherein said object is broken up into two halves and said protrusion goes through the center of both halves.

28. The device of claim 1 wherein said protrusion is in the shape of a screw which is turned to be forced through the center of said object.

29. The device of claim 1 wherein said device is made of biodegradable material.

30. A method for holding an object which melts, drips, or leaves imprints on one's fingers comprising:
placing a device having a protrusion through a center of said object;
placing a side of said object which has said protrusion through it against a slip prevention disk;
holding said device by a handle.
